(19) United States
(12) Patent Application Publication
(10) Pub. No.: US 2009/0290723 A1
(43) Pub. Date: Nov. 26, 2009

(54) Two-way speaker system

(76) Inventor: Jerry Thomas Lindley, Abilene, TX (US)

Correspondence Address: LYNN E BARBER, P O BOX 16528, FORT WORTH, TX, 76162, US

(21) Appl. No.: 12/154,024

(22) Filed: May 20, 2008

(51) Int. Cl. H04B 1/38

(52) U.S. Cl. 381/86

(57) ABSTRACT

A two-way speaker system for a vehicle comprising an exterior two-way speaker, an interior two-way speaker, and a power inverter to power the system from the vehicle battery.

### BACKGROUND OF THE INVENTION

1. Field of the Invention

This invention relates to two-way speaker systems, and in particular, relates to a two-way speaker system for vehicles.

2. Description of the Related Art

It is often useful for vehicle operators to be able to communicate with people outside their vehicle, for example, when at a drive-up facility or when a person approaches the vehicle or is approached by the vehicle. While it many circumstances it is not problematic for the vehicle operator to simply roll down the vehicle window to communicate with someone outside the vehicle, in cases of bad weather or concern about personal safety or for quickness of being able to communicate, it would be of benefit to the vehicle operators in some instances to be able to communicate with someone outside the vehicle without rolling down the window. Typically vehicles are too sound-proofed to allow either party to be heard by the other unless the window is rolled down.

Previous approaches to this problem include the patent of Gilbert et al. (U.S. Pat. No. 7,165,853) for an exterior mirror which has an approach light in its attachment assembly and an intercom system for communication between the interior and exterior of the vehicle by way of the vehicle mirror. The exterior mirror of Olijnyk et al. (U.S. Pat. No. 7,040,770) has a housing and includes lights and may include a variety of accessories such as a turn indicator, bump strip, antenna, spot light, spoiler, power port, corded light, and speaker.

It is also often useful to be able to send out a loud distress signal from a vehicle, such as a locked vehicle or for security or other official vehicles to be able to communicate to others outside the vehicle. It would also be useful to have such two-way communication on public vehicles such as school buses and the like.

None of the previous approaches known to the inventor herein provide a two-way speaker system for a vehicle comprising an exterior two-way speaker, an interior two-way speaker, and a power inverter to power the system from the vehicle battery.

It is therefore an object of the invention to provide a vehicle two-way speaker system.

Other objects and advantages will be more fully apparent from the following disclosure and appended claims.

### SUMMARY OF THE INVENTION

The invention herein is a two-way speaker system for a vehicle comprising an exterior two-way speaker, an interior two-way speaker, and a power inverter to power the system from the vehicle battery.

Other objects and features of the inventions will be more fully apparent from the following disclosure and appended claims.

### BRIEF DESCRIPTION OF THE DRAWINGS

FIG. 1 is a schematic view of the two-way speaker system of the invention.

FIG. 2 is a perspective view of a mounted exterior two-way speaker of the invention.

FIG. 3 is a perspective view of a mounted interior two-way speaker of the invention.

FIG. 4 is a perspective view of an alternate embodiment of an exterior two-way speaker of the invention.

### DETAILED DESCRIPTION OF THE INVENTION AND PREFERRED EMBODIMENTS THEREOF

The present invention is a two-way speaker system for a vehicle comprising an exterior two-way speaker unit, an interior two-way speaker unit, and a power inverter to power the system from the vehicle battery.

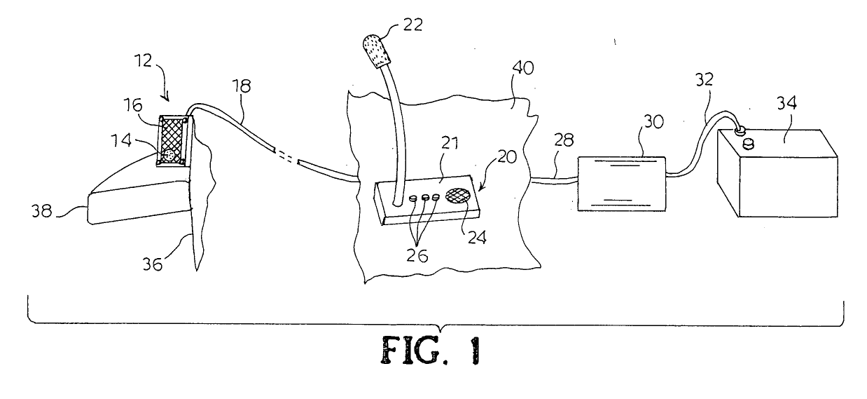

Referring now to the figures, as shown in the schematic diagram of FIG. 1 and in FIGS. 2-3, the two-way speaker system 10 of the invention comprises an exterior speaker unit 12 preferably mounted to the base of the external rear-view mirror 38 on the driver's side of the vehicle 36. The exterior speaker unit 12 has a microphone 14 and speaker 16 incorporated therein. The exterior speaker unit 12 is connected by means of a two-pair wire in a protective tubing 18 to an interior speaker unit 20. The wire can enter be mounted to enter the vehicle from the outside through pre-existing holes or between the door and doorpost, or new holes can be made so that the wire may pass into the vehicle. The pathway the wire travels from the exterior speaker to the interior of the vehicle can be determined as best suits the needs of the vehicle owner and the particular structure of the vehicle. A Norcom Communications Inc TTU-7 speaker unit is useful as the exterior speaker unit 12.

The interior speaker unit 20 is preferably mounted on an interior surface 40, most preferably on the dashboard or console of the vehicle. The interior speaker unit 20 comprises a console 21 having a speaker 24 and a goose-neck microphone 22 for ease of use by the vehicle operator. In addition, the interior speaker unit 20 has control knobs 26, for example, for turning on and off, or alternatively, a 3-way toggle between off, 1-way, and 2-way communication, for adjusting volume, and for squelch as known in the art. A Norcom Communications Inc TTU-3 speaker unit is useful as the interior speaker unit 20 of the invention.

The speakers are plugged in by means of cord 28 to a power inverter 30 that is in turn connected to the vehicle battery 34 by means of cord 32. The power inverter 30 may be placed as desired, with one convenient position being at the location of the ashtray, strapped under the inside speaker. A Black and Decker 200 Watt Power Inverter (12 VAC to 115 VDC output) is useful as the power inverter 30 of the invention. The inverter 30 is preferably plugged into the cigarette lighter of the vehicle.

In an alternative embodiment (not shown), the speakers may be part of a two-way unit and can be built to 12 VDC.

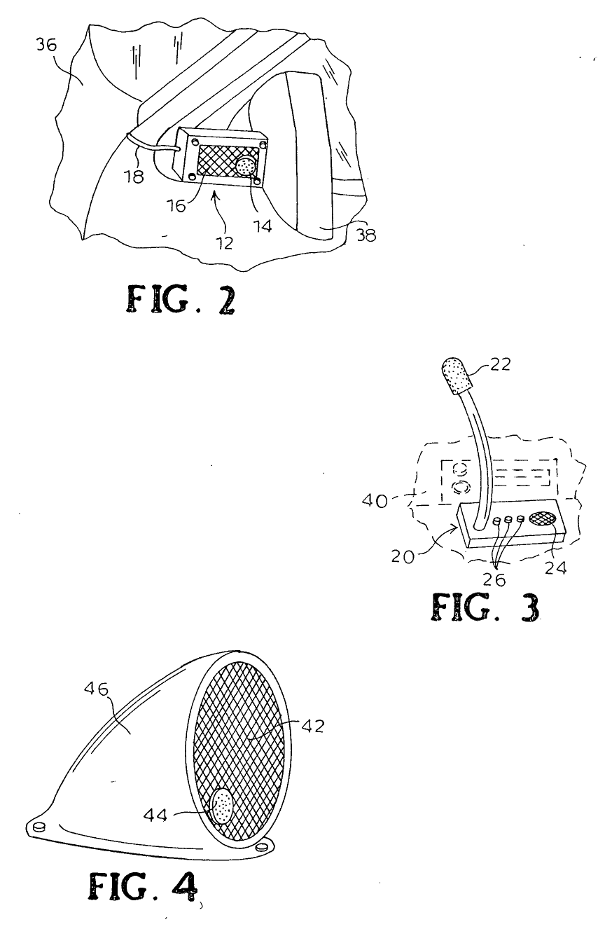

In another alternative embodiment shown in FIG. 4, the external speaker 42 and microphone 44 may be mounted in a new or existing housing 46 for placement on the exterior of the vehicle, for example, on the outside roof of the cab of a truck.

While the parts of the two-way speaker system 10 of the invention can be installed in an existing vehicle, preferably with the cords/wires following existing wiring, they may of course also be installed during construction of a vehicle, and in that case, are preferably installed so that the wires run through the factory wire harness so that they are not visible.

While the invention has been described with reference to specific embodiments, it will be appreciated that numerous variations, modifications, and embodiments are possible, and accordingly, all such variations, modifications, and embodiments are to be regarded as being within the spirit and scope of the invention.

What is claimed is:

1. A two-way speaker system for a vehicle, comprising:
a) an exterior speaker unit mounted on the exterior of the vehicle and having a microphone and a speaker;
b) an interior speaker unit mounted inside the vehicle on an interior surface and having a microphone and a speaker and controls;
c) a wire in a protective tubing connecting the exterior speaker unit to the interior speaker unit; and
d) a power inverter connected to the interior speaker and to the vehicle battery.

2. The two-way speaker system of claim 1, wherein the exterior speaker unit is mounted to the base of the external rear-view mirror of the vehicle.

3. The two-way speaker system of claim 1, wherein the microphone on the interior speaker unit comprises a goose-neck microphone.

4. A two-way speaker system for a vehicle, comprising:
a) an exterior speaker unit mounted on the exterior of the vehicle and having a microphone and a speaker and being mounted to the base of the external rear-view mirror of the vehicle;
b) an interior speaker unit mounted inside the vehicle on an interior surface and having a goose-neck microphone and a speaker and controls;
c) a wire in a protective tubing connecting the exterior speaker unit to the interior speaker unit; and
d) a power inverter connected to the interior speaker and to a vehicle battery.
